(19) United States
(12) Patent Application Publication
(10) Pub. No.: US 2026/0155343 A1
(43) Pub. Date: Jun. 4, 2026

(54) HEALTH DEGRADATION MONITORING OF SCIENTIFIC MEASUREMENT DEVICE

(71) Applicant: HighChem s.r.o., Bratislava (SK)

(72) Inventors: Juraj Lutišan, Beluša (SK); Michal Gramblicka, Bratislava (SK)

(21) Appl. No.: 18/968,449

(22) Filed: Dec. 4, 2024

(51) Int. Cl. H01J 49/14

(52) U.S. Cl. CPC H01J 49/147

(57) ABSTRACT

Embodiments described herein relate to a process for monitoring health degradation of a measurement device, such as a spectrometry device. A system can comprise a memory that stores, and a processor that executes, computer executable components. The computer executable components can comprise a normalizing component that normalizes an accuracy of a spectrometry device based on an expected mass-to-charge ratio corresponding to a selected fragment ion, resulting in a normalized accuracy factor, and a determining component that, based on the normalized accuracy factor, fits a peak, corresponding to the selected fragment ion, of molecular spectral data generated at the spectrometry device to the expected mass-to-charge ratio corresponding to the selected fragment ion.

### BACKGROUND

Calibration of a chemical structure measurement device, and/or monitoring of degradation of accuracy of such measurement device over its life cycle, can be complicated and time-intensive processes, reducing use time with the measurement device and/or taking user entity time away from other tasks. Likewise, comparison of calibration and/or health monitoring data from plural instruments, plural same instrument elements, plural samples, etc. also can be a complicated and time-intensive process, again reducing use time and taking user entity time away from other tasks.

### SUMMARY

The following presents a summary to provide a basic understanding of one or more example embodiments described herein. This summary is not intended to identify key or critical elements, and/or to delineate scope of particular embodiments or scope of claims. Its sole purpose is to present concepts in a simplified form as a prelude to the more detailed description that is presented later. In one or more example embodiments, systems, computer-implemented methods, apparatuses and/or computer program products described herein can provide a plug-and-play process for using data generated by a measurement instrument (also herein referred to as a measurement device) and known chemical compound data to calibrate, normalize and/or compare measurement instrument output data in a time efficient and automatic manner.

In accordance with an embodiment, a system can comprise a memory that stores computer executable components, and a processor that executes the computer executable components. The computer executable components can comprise a normalizing component that normalizes an accuracy of a spectrometry device based on an expected mass-to-charge ratio corresponding to a selected fragment ion, resulting in a normalized accuracy factor, and a determining component that, based on the normalized accuracy factor, fits a peak, corresponding to the selected fragment ion, of molecular spectral data generated at the spectrometry device to the expected mass-to-charge ratio corresponding to the selected fragment ion.

In accordance with another embodiment, a computer-implemented method can comprise normalizing, by a system operatively coupled to a processor, an accuracy of a spectrometry device based on an expected mass-to-charge ratio corresponding to a selected fragment ion, resulting in a normalized accuracy factor, and fitting, by the system, based on the normalized accuracy factor, a peak, corresponding to the selected fragment ion, of molecular spectral data generated at the spectrometry device to the expected mass-to-charge ratio corresponding to the selected fragment ion.

In accordance with still another embodiment, a computer program product facilitates a process for monitoring health of a spectrometry device, the program instructions executable by a processor to cause the processor to normalize, by the processor, an accuracy of a spectrometry device based on an expected mass-to-charge ratio corresponding to a selected fragment ion, resulting in a normalized accuracy factor, and fit, by the processor, based on the normalized accuracy factor, a peak, corresponding to the selected fragment ion, of molecular spectral data generated at the spectrometry device to the expected mass-to-charge ratio corresponding to the selected fragment ion.

The one or more example embodiments described herein can be implemented within, in connection with and/or coupled to a chemical structure measurement device.

The one or more example embodiments disclosed herein can be applied on a plug-and-play basis to a measurement device, plural measurement devices, a same measurement device using plural exchangeable components, etc. for calibration, normalization and/or comparison of output data relative to known and/or standard data. The frameworks described herein can be performed in a time efficient and at least partially automatic manner, thereby increasing device use time and/or reducing user entity interaction for pre-experiment processes. This can likewise reduce unintentional error caused by manual calibration by a user entity.

The one or more example embodiments described herein can employ a unitless criterion of an accuracy factor determined based on acquired, estimated and/or expected (also herein referring to as theoretical) data relating to a measurement device and a same selected fragment ion. The unitless criterion can be employed to normalize output data of the measurement device, such as to fit a spectral peak of output data based on expected mass-to-charge ratio values.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 illustrates a block diagram of an example, non-limiting system that can facilitate a process for monitoring health degradation of a measurement device, in accordance with one or more example embodiments described herein.

FIG. 2 illustrates a block diagram of another example, non-limiting system that can facilitate a process for monitoring health degradation of a measurement device, in accordance with one or more example embodiments described herein.

FIG. 3 illustrates an example graph illustrating health degradation plotted over time for an example measurement device, in accordance with one or more example embodiments described herein.

FIG. 4 illustrates another example graph illustrating a positive polarity health degradation plotted separately from a negative polarity health degradation and plotted over time for an example measurement device, in accordance with one or more example embodiments described herein.

FIG. 5 illustrates a schematic diagram of one or more processes that can be performed by the non-limiting system of FIG. 2, in accordance with one or more example embodiments described herein.

FIG. 6 illustrates a flow diagram of one or more processes that can be performed by the non-limiting system of FIG. 1, in accordance with one or more example embodiments described herein.

FIG. 7 illustrates another flow diagram of one or more processes that can be performed by the non-limiting system of FIG. 2, in accordance with one or more example embodiments described herein.

FIG. 8 illustrates a continuation of the flow diagram of FIG. 7 of one or more processes that can be performed by the non-limiting system of FIG. 2, in accordance with one or more example embodiments described herein.

FIG. 9 illustrates a block diagram of an example operating environment into which embodiments of the subject matter described herein can be incorporated.

FIG. 10 illustrates an example schematic block diagram of a computing environment with which the subject matter described herein can interact and/or be implemented at least in part.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section.

Turning first to the subject of chemical structure measurement devices generally, such measurement devices can comprise, but are not limited to, spectrometry devices, chromatography devices, etc. These measurement devices, over time ranging from hours to days, and longer (e.g., months) can exhibit degradation of health which can manifest, for example, as accuracy creep. Such accuracy creep can be relative to measurements taken and/or output results output, as compared to theoretical or expected measurement values. Different measurement devices and/or components of measurement devices can have different deterioration speeds relative to the respective accuracies. In one or more cases identification and/or measurement of some ions can (e.g., negative polarity ions) can degrade more rapidly than identification and/or measurement of other ions (e.g., positive polarity ions). Due to this accuracy creep, in existing frameworks, a measurement device can be calibrated prior to each use, or even more often, such as prior to each experiment.

To account for one or more deficiencies of existing frameworks, one or more frameworks described herein can be employed to rapidly and/or automatically monitor health degradation of a measurement device, such as based on a generated accuracy factor of a measurement device per instance of monitoring. For example, an accuracy factor can be employed to determine a state of health and/or calibration of a measurement device and/or to compare measurement devices, acquisitions, measurement device components, etc.

Generally, the one or more frameworks described herein can be employed to enhance understanding of accuracy, calibration, device health, etc., of a measurement device such as based on expected accuracy, estimated accuracy and acquired accuracy for a fragment ion as analyzed by the measurement device. The expected accuracy, estimated accuracy and/or acquired accuracy can be obtained relative to a same fragment ion (e.g., molecular ion resulting from a molecular spectrometry process (e.g., MS, MS², MSⁿ, etc.), such as a common fragment ion for which expected accuracy values are historically known. An output of the one or more frameworks described herein can be a unitless accuracy factor (af) which itself can be an indicator of overall current accuracy of the corresponding measurement device.

That is, the one or more example embodiments described herein can be employed to monitor spectrometry device health degradation based on determined accuracy as related to specified fragment ions measured by the spectrometry device. The one or more example embodiments can utilize aggregations of expected, acquired and/or estimated measurement values to normalize an accuracy of a spectrometry device based on a specified fragment ion, can fit a peak of spectral data based on the normalized accuracy factor, and/or can optionally determine a delta accuracy of the spectrometry device employing data corresponding to the same specified fragment ion. Put another way, the accuracy factor provides a criterion for the accuracy of the spectrometry device that is normalized to an expected mass-to-charge ratio (m/z) of a specified fragment ion and expressed as a multiplier of an estimated accuracy corresponding to the specified fragment ion. As a result, a spectral peak corresponding to the specified fragment ion, as output by the measurement device, can be fit to an expected m/z also corresponding to the specified fragment ion.

As a result of an output of one or more accuracy factors and/or fittings, one or more resulting delta accuracies can be determined for the spectrometry device. A dataset comprising the one or more accuracy factors and/or delta accuracies can be employed to calibrate, understand accuracy of, and/or compare accuracy of a measurement device, in a time efficient manner.

Various health monitoring evaluations can be performed based on output of the unitless accuracy factor and/or based on output of two or more unitless accuracy factors for a same measurement device or for plural measurement devices. For example, accuracy factors obtained over time can be plotted and/or compared to aid in determining whether a measurement device is out of calibration and/or is exhibiting overall health degradation.

For example, two first accuracy factors obtained within a first given time range can be similar, indicating an out-of-calibration state. Differently, two additional accuracy factors obtained over a second time range after the first time range can indicate reduction in measurement device health over time (e.g., the two additional accuracy factors do not merely have values similar to one or both of the two first accuracy factors).

For another example, accuracy factors taken during a same given time period for different measurement devices can be compared to one another. Here, comparison can indicate higher accuracy of one measurement device as compared to another measurement device, for example.

For another example, accuracy factors taken during a same given time period and corresponding to different fragment ions detected at a same measurement device can be compared to one another. Here, comparison can indicate higher accuracy of the measurement device relative to one fragment ion as compared to accuracy of the measurement device relative to another, and different, fragment ion.

Regardless of example, one or more such comparisons can be performed based on one or more determinations of accuracy of a measurement device that can be automatically obtained in a time efficient manner taking less time than existing frameworks.

As used herein, the phrase “based on” should be understood to mean “based at least in part on,” unless otherwise specified.

As used herein, the term “data” can comprise metadata.

As used herein, the terms “entity,” “requesting entity,” and “user entity” can refer to a machine, device, component, hardware, software, smart device, party, organization, individual and/or human.

As used herein, the term “sample” can refer to a single material, multiple materials, composition, compound, solution, product, etc.

One or more example embodiments are now described with reference to the drawings, where like referenced numerals are used to refer to like drawing elements throughout. In the following description, for purposes of explanation, numerous specific details are set forth in order to provide a more thorough understanding of the one or more example embodiments. It is evident in various cases, however, that the one or more example embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

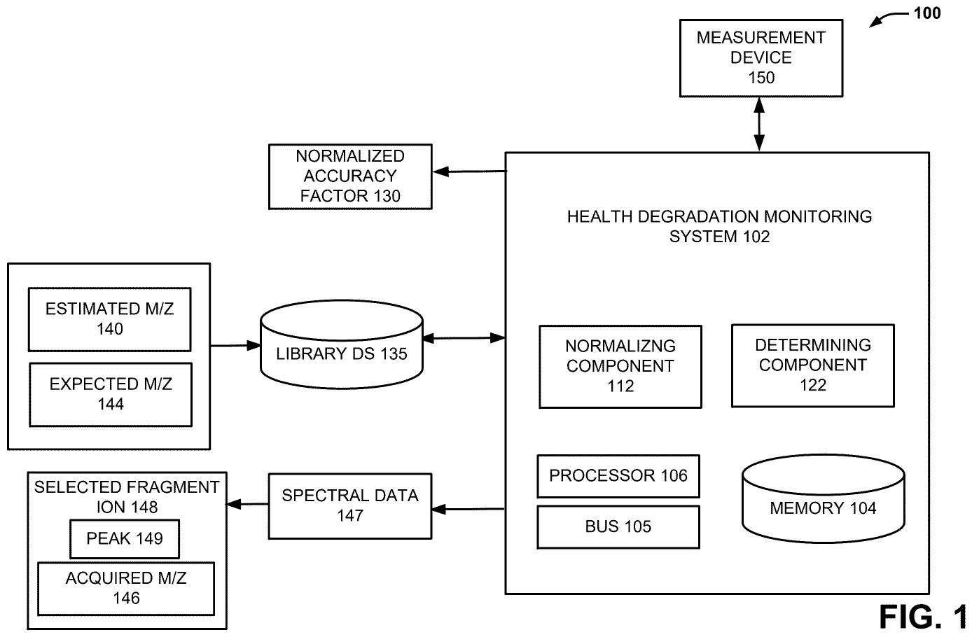

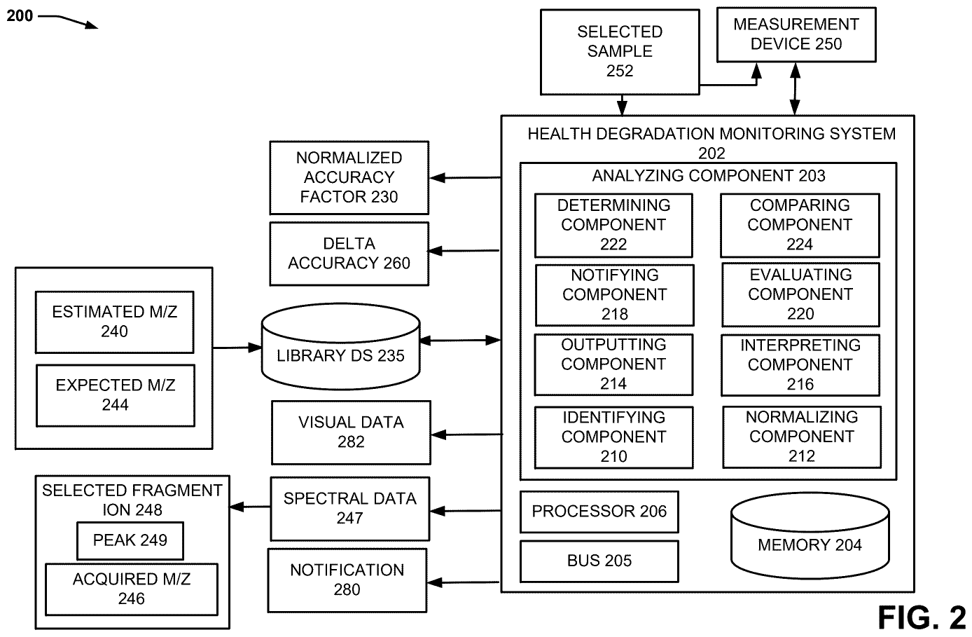

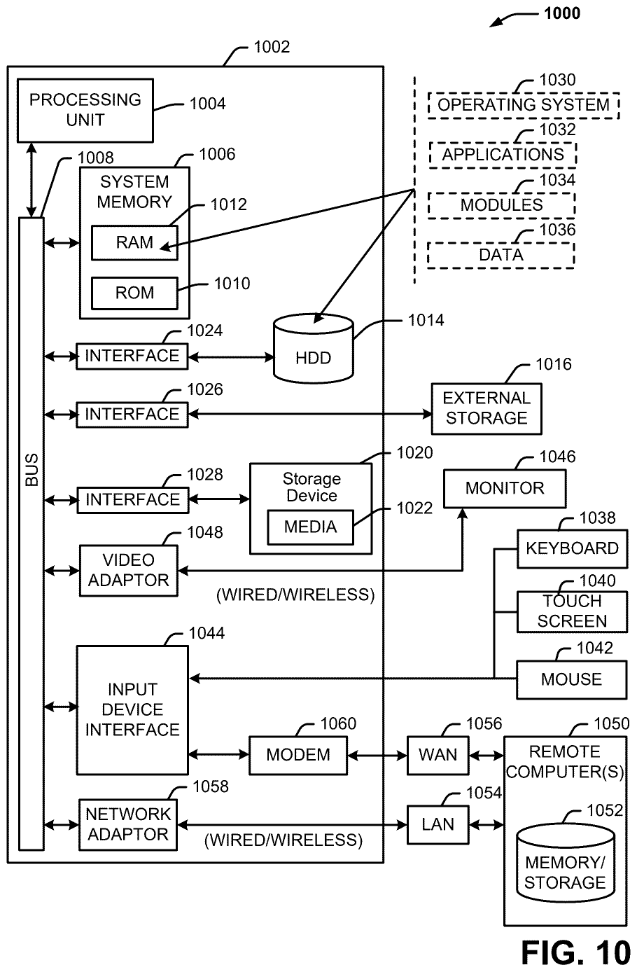

Referring now to FIGS. 1 and 2, in one or more example embodiments, the non-limiting systems 100 and/or 200 illustrated at FIGS. 1 and 2, and/or systems thereof, can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1 and/or 2 and/or with other figures described herein.

Turning first to FIG. 1, the figure illustrates a block diagram of an example, non-limiting system 100 that can comprise a health degradation monitoring system 102 and a library datastore (DS) 135. Optionally, the non-limiting system 100 can comprise a measurement device 150 (e.g., a spectrometry device or other scientific measurement device). In one or more other embodiments, the measurement device 150 and/or library datastore 135 can be located external to the health degradation monitoring system 102 which can be communicatively coupled to the measurement device 150 and/or library datastore 135.

It is noted that the health degradation monitoring system 102 is only briefly detailed to provide but a lead-in to a more complex and/or more expansive health degradation monitoring system 202 as illustrated at FIG. 2. That is, further detail regarding processes that can be performed by one or more example embodiments described herein will be provided below relative to the non-limiting system 200 of FIG. 2.

Still referring to FIG. 1, the health degradation monitoring system 102 can generally facilitate monitoring of health degradation of the measurement device 150 based on determined accuracy as related to specified fragment ions measured by the measurement device 150 (e.g., spectrometry device), such as based on a unitless accuracy factor 130 corresponding to a selected fragment ion 148. The health degradation monitoring system 102 can comprise at least a memory 104, bus 105, processor 106, normalizing component 112 and/or determining component 122. The processor 106 can be the same as the processor 1004 (FIG. 10), comprised by the processor 1004 or different therefrom. The memory 104 can be the same as the system memory 1006 (FIG. 10), comprised by the system memory 1006 or different therefrom.

Using the above-noted components, the health degradation monitoring system 102 can facilitate a process to determine and employ expected, acquired and estimated measurement values in an aggregated format to classify a degradation of health of the measurement device 150. As a result, the health degradation monitoring system 102 can generate one or more values (e.g., normalized accuracy factor 130 and/or delta accuracy 160) upon which a determination of health of the measurement device 150.

Generally, the normalizing component 112 can normalize an accuracy of the spectrometry device 150 based on an expected mass-to-charge ratio (m/z) 144 corresponding to a selected fragment ion 148, generally resulting in a normalized accuracy factor 130. The selected fragment ion 148 can be a known fragment ion, a common fragment ion, a standardized fragment ion, etc., such that information regarding the fragment ion 148, such as expected m/z 144 (e.g., corresponding to the selected fragment ion 148) and/or estimated m/z 140 (e.g., corresponding to a combination of the selected fragment ion 148 and measurement device 150), can be stored at and obtained from a library datastore 135 communicatively coupled to the health degradation monitoring system 102. Put another way, to be explained below in greater detail, the accuracy factor (e.g., normalized accuracy factor 130) can provide (e.g., comprise and/or is) a criterion for the accuracy of the spectrometry device 150 that is normalized to a theoretical m/z (e.g., expected m/z 144) of a specified fragment ion 148 and expressed as a multiplier of an estimated accuracy (e.g., estimated m/z 140) corresponding to the specified fragment ion 148 and spectrometry device 150 combination.

As a result, a spectral peak 149 corresponding to the specified fragment ion 148, as output by the measurement device 250, can be fit to the expected m/z 144. That is, the determining component 122 generally can fit a peak 149, corresponding to the selected fragment ion 148, of molecular spectral data generated at the spectrometry device 150, to the expected mass-to-charge ratio 144 corresponding to the selected fragment ion 148, based on the normalized accuracy factor 130. This can comprise determining a resulting delta accuracy 160 of the spectrometry device 150 based on a change and/or difference between an acquired m/z value of the peak 149 and the expected mass-to-charge ratio 144.

In one or more cases, the determining component 122 and/or the processor 106, can make a determination whether additional understanding of the spectrometry device 150 accuracy is desired. This can be based on data and/or other communication input by a user entity using a computing device communicatively coupled to the non-limiting system 100 and/or based on a determination by the determining component 122, such as based on a default indication to proceed to determining a delta accuracy 160.

As a result of these components, the data generated (e.g., normalized accuracy factor 130 and/or delta accuracy 160) can be stored, such as at the library datastore 135.

The normalizing component 112 and/or determining component 122 can be operatively coupled to the processor 106 which can be operatively coupled to the memory 104. The bus 105 can provide for the operative coupling. The processor 106 can facilitate execution of the normalizing component 112 and/or determining component 122. The normalizing component 112 and/or determining component 122 can be stored at the memory 104.

In general, the non-limiting system 100 can employ any suitable method of communication (e.g., electronic, communicative, internet, infrared, fiber, etc.) to provide communication between the health degradation monitoring system 102 and/or any device associated with a user entity.

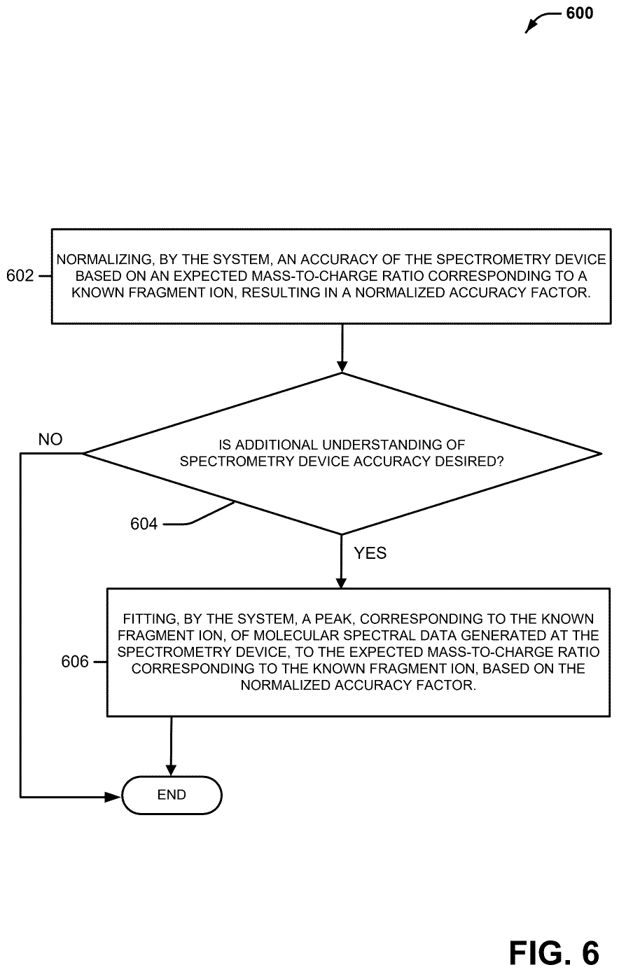

As a summary of the above-described components and functions thereof, referring next only briefly to FIG. 6, illustrated is a flow diagram of an example, non-limiting method 600 that can facilitate a process to monitor health degradation of the measurement device 150 (e.g., spectrometry device), in accordance with one or more example embodiments described herein, such as the non-limiting system 100 of FIG. 1. While the non-limiting method 600 is described relative to the non-limiting system 100 of FIG. 1, the non-limiting method 600 can be applicable also to other systems described herein, such as the non-limiting system 200 of FIG. 2. Repetitive description of like elements and/or processes employed in respective embodiments is omitted for sake of brevity.

At 602, the non-limiting method 600 can comprise normalizing, by a system (e.g., normalizing component 212), operatively coupled to a processor (e.g., processor 106), an accuracy of a spectrometry device (e.g., spectrometry device 150) based on an expected mass-to-charge ratio (e.g., expected m/z 144) corresponding to a selected fragment ion (e.g., selected fragment ion 148), resulting in a normalized accuracy factor (normalized accuracy factor 130).

At 604, the non-limiting method 600 can comprise determining, by the system (e.g., determining component 122), whether additional understanding of the spectrometry device accuracy is desired. This can be based on data or other communication input by a user entity using a computing device communicatively coupled to the non-limiting system 100 and/or based on a determination by the determining component 122, such as based on a default indication to proceed to determining a delta accuracy (e.g., delta accuracy 160). If yes, the non-limiting method 600 can proceed to step 606. If not, the non-limiting method can proceed to end.

At 606, the non-limiting method 600 can comprise fitting, by the system (e.g., determining component 122) a peak (e.g., peak 149), corresponding to the selected fragment ion, of molecular spectral data (e.g., spectral data 147) generated at the spectrometry device, to the expected mass-to-charge ratio corresponding to the selected fragment ion, based on the normalized accuracy factor.

As described above relative to the determining component 122, but also applicable to the determining component 222, fitting can comprise changing, calibrating, determining a delta accuracy 260, etc. for one or more fragment ions including the selected fragment ion 148, 248.

Turning next to FIG. 2, a non-limiting system 200 is illustrated that can comprise a health degradation monitoring system 202 and a library datastore (DS) 235. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the health degradation monitoring system 202 can facilitate monitoring of health degradation of a measurement device 250 based on determined accuracy as related to specified fragment ions measured by the spectrometry device, such as based on a unitless accuracy factor 230 corresponding to a selected fragment ion 248. That is, put another way, the one or more embodiment described relative to FIG. 2 can facilitate a process to determine and employ expected, acquired and estimated measurement values in an aggregated format to classify a degradation of health of the measurement device 250.

In one or more example embodiments, the health degradation monitoring system 202 can be at least partially comprised by a computing device internal to, external to and/or associated with the measurement device 250 being analyzed by the health degradation monitoring system 202. In one or more other embodiments, the health degradation monitoring system 202 can be separate from the measurement device 250 (e.g., located external to the measurement device 250) and/or the measurement device 250 can be separate from the non-limiting system 200 (e.g., located external to the non-limiting system 200).

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

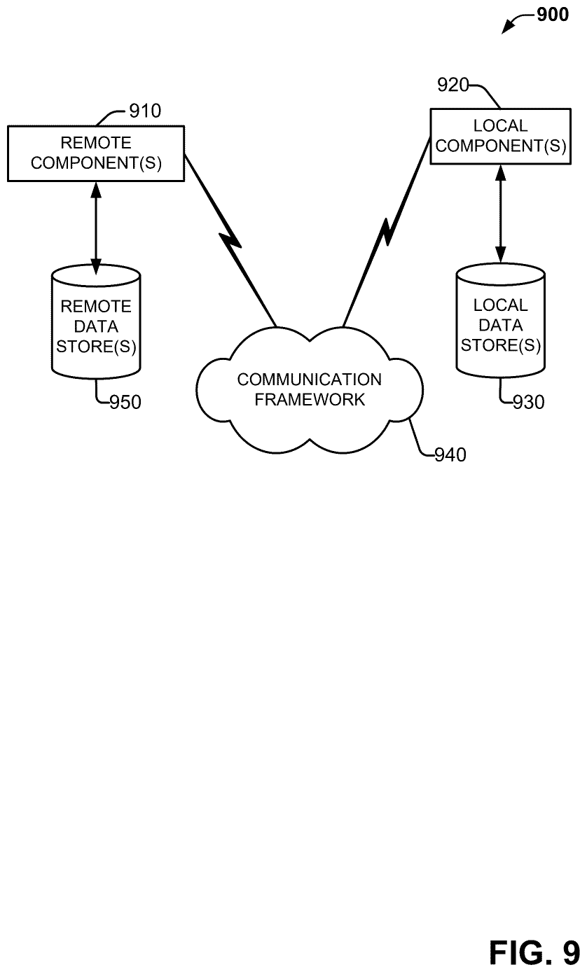

The health degradation monitoring system 202 can be associated with, such as accessible via, a cloud computing environment, such as the cloud computing environment 900 of FIG. 9.

The health degradation monitoring system 202 can comprise a plurality of components. The components can comprise a memory 204, processor 206, bus 205, identifying component 210, normalizing component 212, outputting component 214, interpreting component 216, notifying component 218, evaluating component 220, determining component 222, and/or comparing component 224. Using these components, the health degradation monitoring system 202 can facilitate a process to generate one or more values upon which a determination of health of the measurement device 250.

Discussion next turns to the processor 206, memory 204 and bus 205 of the health degradation monitoring system 202. For example, in one or more example embodiments, the health degradation monitoring system 202 can comprise the processor 206 (e.g., computer processing unit, microprocessor, classical processor, quantum processor and/or like processor). In one or more example embodiments, a component associated with health degradation monitoring system 202, as described herein with or without reference to the one or more figures of the one or more example embodiments, can comprise one or more computer and/or machine readable, writable and/or executable components and/or instructions that can be executed by processor 206 to provide performance of one or more processes defined by such component and/or instruction. In one or more example embodiments, the processor 206 can comprise the identifying component 210, normalizing component 212, outputting component 214, interpreting component 216, notifying component 218, evaluating component 220, determining component 222, and/or comparing component 224.

In one or more example embodiments, the health degradation monitoring system 202 can comprise the computer-readable memory 204 that can be operably connected to the processor 206. The memory 204 can store computer-executable instructions that, upon execution by the processor 206, can cause the processor 206 and/or one or more other components of the health degradation monitoring system 202 (e.g., identifying component 210, normalizing component 212, outputting component 214, interpreting component 216, notifying component 218, evaluating component 220, determining component 222, and/or comparing component 224) to perform one or more actions. In one or more example embodiments, the memory 204 can store computer-executable components (e.g., identifying component 210, normalizing component 212, outputting component 214, interpreting component 216, notifying component 218, evaluating component 220, determining component 222, and/or comparing component 224).

The health degradation monitoring system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more example embodiments, the health degradation monitoring system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more example embodiments, one or more of the components of the health degradation monitoring system 202 and/or of the non-limiting system 200 can reside in the cloud, and/or can reside locally in a local computing environment (e.g., at a specified location).

In addition to the processor 206 and/or memory 204 described above, the health degradation monitoring system 202 can comprise one or more computer and/or machine readable, writable and/or executable components and/or instructions that, when executed by processor 206, can provide performance of one or more operations defined by such component and/or instruction.

Discussion next turns to the additional components of the health degradation monitoring system 202 (e.g., identifying component 210, normalizing component 212, outputting component 214, interpreting component 216, notifying component 218, evaluating component 220, determining component 222, and/or comparing component 224). Generally, the health degradation monitoring system 202 can perform a set of processes that can be separated into various steps comprising, but not limited to: normalizing of accuracy of the measurement device 250 resulting in a normalized accuracy factor 230, fitting of a peak of spectral data based on the normalized accuracy factor 230, and/or evaluation of health of the measurement device 250.

First, it is noted that in one or more example embodiments, the identifying component 210, normalizing component 212, outputting component 214, interpreting component 216, notifying component 218, evaluating component 220, determining component 222, and/or comparing component 224 can be implemented independently, without one or more other of the identifying component 210, normalizing component 212, outputting component 214, interpreting component 216, notifying component 218, evaluating component 220, determining component 222, and/or comparing component 224. Additionally and/or alternatively, the identifying component 210, normalizing component 212, outputting component 214, interpreting component 216, notifying component 218, evaluating component 220, determining component 222, and/or comparing component 224 can be comprised by a high-level analyzing component 203, one or more of the below-described functions of the identifying component 210, normalizing component 212, outputting component 214, interpreting component 216, notifying component 218, evaluating component 220, determining component 222, and/or comparing component 224 can be performed by the high-level analyzing component 203, and/or the identifying component 210, normalizing component 212, outputting component 214, interpreting component 216, notifying component 218, evaluating component 220, determining component 222, and/or comparing component 224 can be omitted with the high-level analyzing component 203 performing one or more of the below-described functions of the one or more omitted identifying component 210, normalizing component 212, outputting component 214, interpreting component 216, notifying component 218, evaluating component 220, determining component 222, and/or comparing component 224.

As noted above, a first set of one or more processes can comprise normalizing an accuracy of the measurement device 250 using a known or selected fragment ion 248 (e.g., an in-silico fragment ion) and corresponding mass-to-charge ratio data for that selected fragment ion 248.

Turning first to the identifying component 210, this component can generally acquire (e.g., obtain, locate, identify, request, download, etc.) molecular spectral data 247 for a sample (e.g., element, compound, material, etc.) 252 analyzed at the measurement device (e.g., scientific measurement device such as a spectrometry device) 250 (e.g., the same measurement device 250 for which the health monitoring is being performed).

Based thereon, the identifying component 210 can retrieve mass-to-charge ratio (m/z) data for a known fragment ion 248 of the sample 252, such as acquired m/z data comprising an acquired m/z 246 (e.g., acquired m/z value). The m/z data retrieved from by the identifying component 210 can comprise acquired m/z data comprising one or more acquired m/z values 246 for the selected fragment ion 248 based on a current condition and/or current health of the measurement device 250.

For example, a known sample 252 can be employed at the measurement device 250 for obtaining the molecular spectral data 247. The known sample 252 being analyzed by the measurement device 250 can result in a set of one or more known fragment ions 248. Alternatively, an unknown sample 252 can be employed, with a matching step allowing for identification of a spectral data peak, of the spectral data 247, to thereby identify a fragment ion 248 of the sample. The matching step can be performed by the identifying component 210, processor 206, and/or component and/or system other than the health degradation monitoring system 202.

Note that a spectral data peak, as used herein, refers to a peak in the data and does not require visual graphing of the spectral data 247.

The spectral data 247 can be in any suitable form, comprise data and/or metadata, and/or can be based on and/or comprised by a spectrum or data underlying a spectrum, etc.

In one or more cases, the spectrum can comprise an electron impact MS¹ spectrum or soft ionization MSⁿ spectrum after generation of one or more in-silico fragments from the sample 252 by the measurement device 250.

In one or more embodiments, the identifying component 210 also can acquire (e.g., obtain, locate, identify, request, download, etc.) an estimated m/z 240 for the selected fragment ion 248 based on a current condition and/or current health of the measurement device 250. The estimated m/z 240 can be generated by a process understood by one having ordinary skill in the art using one or more criterion of measurement device analyzer, resolution, peak height, ion injection time, etc.

Next, and/or at least partially in parallel with the above process, based on identification of the selected fragment ion 248, the identifying component 210 can acquire (e.g., obtain, locate, identify, request, download, etc.) an expected m/z 244 corresponding to the selected fragment ion 248.

In one or more cases the expected m/z 244 can be a default expected m/z 244 corresponding to any measurement device 250, or alternatively, can correspond in particular to at least the measurement device 250 being monitored for health (e.g., based on the hardware, software and/or firmware of the particular measurement device 250 being monitored).

As an example, the identifying component 210 can acquire the expected m/z 244 as an expected m/z value from the library datastore 235. As an example, a sample 252 structure, formula and/or m/z values can be located at a raw file, such as a comma-separated value (csv) file or database system, such as the library datastore 235.

As another example, the identifying component 210 can acquire the expected m/z 244 as an expected m/z value from the library datastore 235 or other native location where the file comprises structure information for the sample 252 or structure information specifically regarding the selected fragment ion 248.

As another example, an expected m/z 244 criteria can be generated where the sample 252 is an unknown sample 252. This generation can be based on identification of the selected fragment ion 248 as a commonly occurring ion in MS″ spectra, such as where historical and/or known data is comprised by the library datastore 235.

Additionally, and/or alternatively, relative to an unknown sample 252, common neutral losses observed (e.g., loss of H₂O, NH₃, CO, CO₂, sugars, etc.) on MS¹ spectra (for in-source ions) or on MSⁿ spectra can be employed. In such case, the identifying component 210 can acquire acquired m/z 246 values for a pair of peaks 249 corresponding to the selected fragment ion 248 and to another selected fragment ion (different from the selected fragment ion 248). In connection therewith, the identifying component 210 can acquire the expected m/z 244 comprising the theoretical value of neutral loss corresponding to the selected fragment ion 248 and another selected fragment ion. Also in connection therewith, the identifying component 210 can acquire the estimated m/z 240 comprising a sum of the estimated m/z 240 values for the pair of peaks 249. That is, in one or more cases, this sum can be acquired or otherwise generated. For example, the normalizing component 212 can, based on a first estimated m/z 240 value for the first peak 249 and a second estimated m/z 240 value for the second peak 249, generate a sum of the two estimated m/z 240 values.

Additionally, and/or alternatively, relative to an unknown sample 252, the identifying component 210 can identify a commonly occurring impurity from spectral data 247 obtained by the measurement device 250. This can be a commonly occurring impurity of a MS¹ spectrum, such as a plasticizers, antioxidants such as industrial antioxidants, leachables, extractables, etc. The spectral data 247 can be stored at a library datastore 235 accessible by the health degradation monitoring system, at an online database, etc.

In any two or more of the above cases, data acquired by the identifying component 210 can be combined and/or aggregated to provide the expected m/z 244 relative to measurement device 250 and/or the selected ion fragment 248.

In any one or more of the above cases, the identifying component 210 can store the data obtained, generated, and/or acquired, such as data acquired from an external datastore, generated for an unknown sample 252 and/or acquired for an unknown sample 252, at the library datastore 235 for future use by the measurement device 250 and/or health degradation monitoring system 202. The data can comprise metadata and/or can be stored in any suitable format.

As a brief summary of the above, an acquired m/z 246, expected m/z 244, and/or estimated m/z 240 can have been acquired by the identifying component 210.

The normalizing component 212 can employ the acquired m/z 246, expected m/z 244, and/or estimated m/z 240 to determine an accuracy factor (af) for the measurement device 250, which af can be output by the outputting component 214.

Using Equation 1, the normalizing component 212 can generate an absolute difference between acquire m/z 246 and expected m/z 240.

$$Δ ( m / z ) = m / {z}_{acquired} - m / {z}_{expected} . \qquad Equation 1$$

In one or more cases, the output of Equation 1 can be generally referred to as an estimated accuracy of the measurement device 250.

Using the result of Equation 1, and using Equation 2, the normalizing component 212 can determine the af being a multiplier off an estimated accuracy of the measurement device 250, and being based on normalizing of an accuracy of the measurement device 250 relative to a selected fragment ion 248.

$$af = \frac{\vert {Δ ( mz )}_{abs} \vert}{{Δ ( mz )}_{estimated}} . \qquad Equation 2$$

The outputting component 214 can output the accuracy factor being the resulting normalized accuracy factor 230 to a user entity, such as communicating the normalized accuracy factor 230 to a computing device communicatively couplable to the health degradation monitoring system 202 and associated with the user entity.

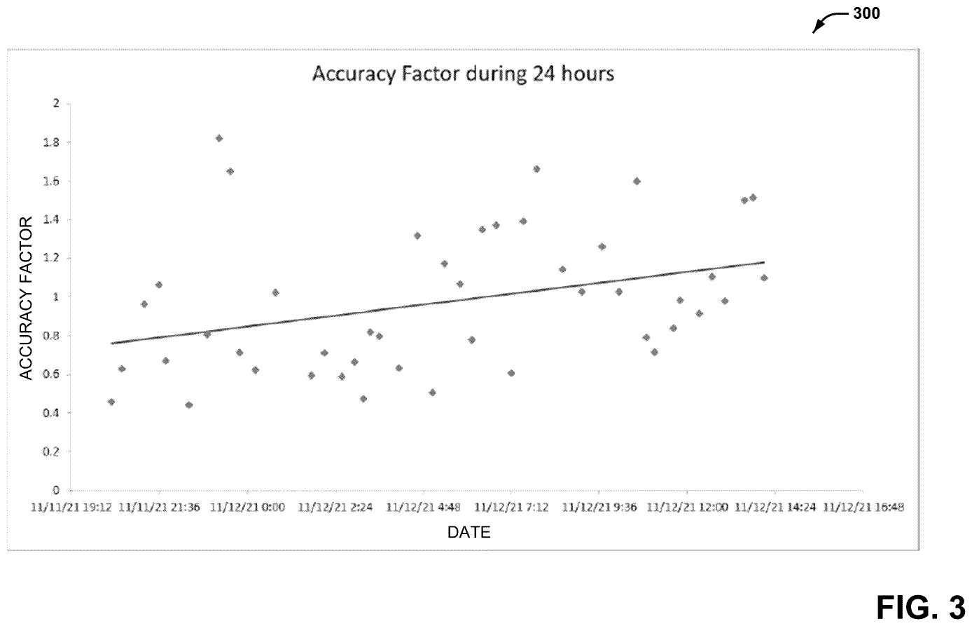

In one or more embodiments, the outputting component 214 can group a set of acquired data, such as acquired m/z 246 values, normalized accuracy factors 230 and/or delta accuracies 260. Grouping can be based on any suitable limitations, such as accuracy factors 230 generated for a specified measurement device 250. In one or more cases, the outputting component 214 can generate visual data 282 to be visualized at a graphical user interface and/or screen of a computing device communicatively coupled to the non-limiting system 200. In one or more other cases, the outputting component 214 can transmit and/or request downloading of such visual data 282. The visual data 282 can comprise data and/or metadata defining a comparison of accuracy factors to time of acquisition, such as illustrated at FIG. 3 (to be described below in greater detail).

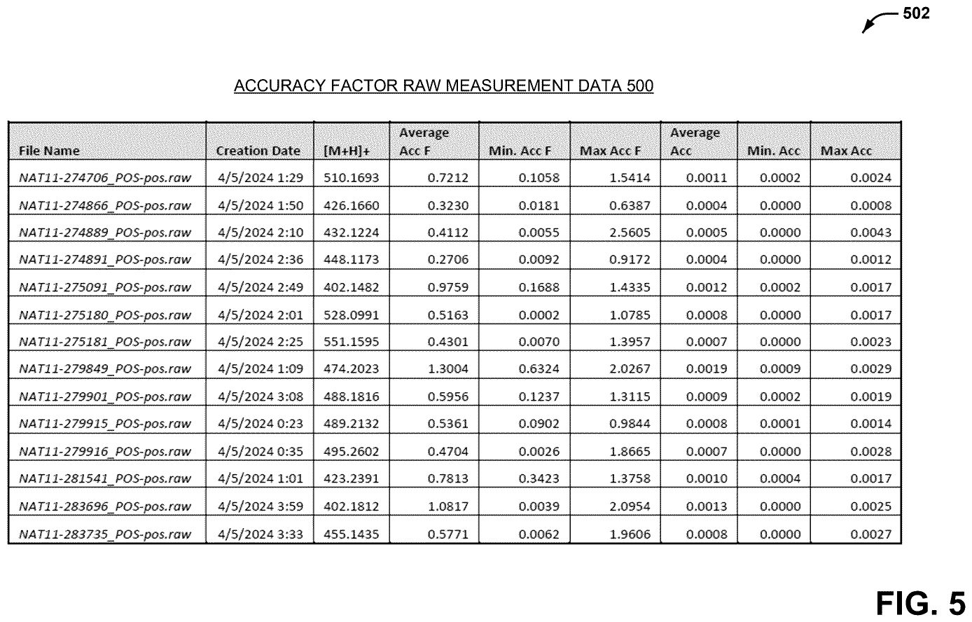

Turning briefly to FIG. 5, illustrated is a set of af data 500 that can be exemplarily output by the outputting component 214. The set of af data 500 can comprise file names, acquisition/creation date, and/or various accuracy factors 230, without being limited thereto. A raw file (e.g., one row in the table 502) is illustrated as including data for a single known compound with known structure. The third column lists the m/z value of the [M+H]+ ion for that compound. An [M+H]+ ion is a positively charged molecular ion that can be formed when a proton is added to a neutral molecule, M, where the H is the additional proton.

The interpreting component 216 can interpret the normalized accuracy factor as comprising a per-centroid peak unitless accuracy criterion normalized to value one. That is, an advantage of the one or more embodiments described herein is a generation, by the normalizing component 212, of a normalized accuracy factor 230 that is a unitless criterion, allowing for easy application of the af 230 to one or more peaks 249 of one or more sets of spectral data 247 output by the measurement device 250, and/or for application of the af 230 to one or more other calibration and/or health monitoring equations. In particular, the interpreting component 216 can employ a health threshold value of 1 for the af 230, where a value greater than 1 is interpreted as indicative of an acquisition issue with the measurement device 250. It is noted that any suitable health threshold value can be employed, different from 1, such as 1.5, 2.0, etc. It is noted that different threshold values can be suitable for different types and/or brands of measurement devices, such as based on different hardware, firmware and/or software used.

In response to a determination of the normalized accuracy factor being a value that is greater than 1, the notifying component 218 can notify a user entity of the potential acquisition issue with the measurement device 250, such as by communicating the normalized accuracy factor 230 to a computing device communicatively couplable to the health degradation monitoring system 202 and associated with the user entity.

As noted above, a second set of one or more processes can comprise fitting of a peak of spectral data based on the normalized accuracy factor 230. For example, the determining component 222 can apply the normalized accuracy factor 230 to a value of a peak 249, such as of the selected fragment ion 248, of a set of spectral data 247 output by the measurement device 250, to normalize/calibrate at least the selected fragment ion 248 relative to the spectral data 247. In one or more cases, this can comprise improving the accuracy of the value of the peak 249 using the normalized accuracy factor 230 and appropriately updating the value within the spectral data 247. In one or more cases, the above processes can instead be additionally applied, separately (such as at least partially in parallel with one another), to one or more other selected fragment ions 248 of the spectral data 247.

In one or more cases, the determining component 222 can identify the aforementioned change in accuracy as a delta accuracy 260. This delta accuracy 260, as noted above, can be applied merely to the selected fragment ion 248 and/or to one or more fragment ions of the spectral data 247. Likewise, this delta accuracy 260 can be output by the outputting component 214 to a user entity, such as communicating the normalized accuracy factor 230 to a computing device communicatively couplable to the health degradation monitoring system 202 and associated with the user entity.

As noted above, a third set of one or more processes can comprise evaluation of health of the measurement device 250, which can comprise use of the normalized accuracy factor 230 and/or delta accuracy 260. For example, the evaluating component 220 can perform one or more evaluations based on the output of the unitless and normalized accuracy factor 230, and/or based on output of two or more unitless accuracy factors 230 for a same measurement device 250 or for plural measurement devices (including the measurement device 250 and another measurement device). For example, accuracy factors 230 obtained over time can be plotted and/or compared to aid in determining whether the measurement device 250 is out of calibration and/or is exhibiting overall health degradation.

Direction is turned briefly to FIG. 3, illustrating an example accuracy factor graph 300 for a measurement device 250 based on accuracy factors 230 acquired over a period of 24 hours. The x-axis provides the date and time of acquisition. The y-axis provides the output accuracy factor 230 (e.g., output by the outputting component 214). As illustrated, absent calibration, for a selected fragment ion 248, the accuracy factors 230 for the measurement device 250, and thus the accuracy for the measurement device 250 more generally, degrades over a 24 hour period. As shown, the health threshold of 1 is satisfied up to about 12 hours into the 12 hour period, at which time the notifying component 218 can output an indication of an acquisition issue for the measurement device 250 based on output from the interpreting component 216 (e.g., using the health threshold), such as by outputting a notification 280 in any suitable format.

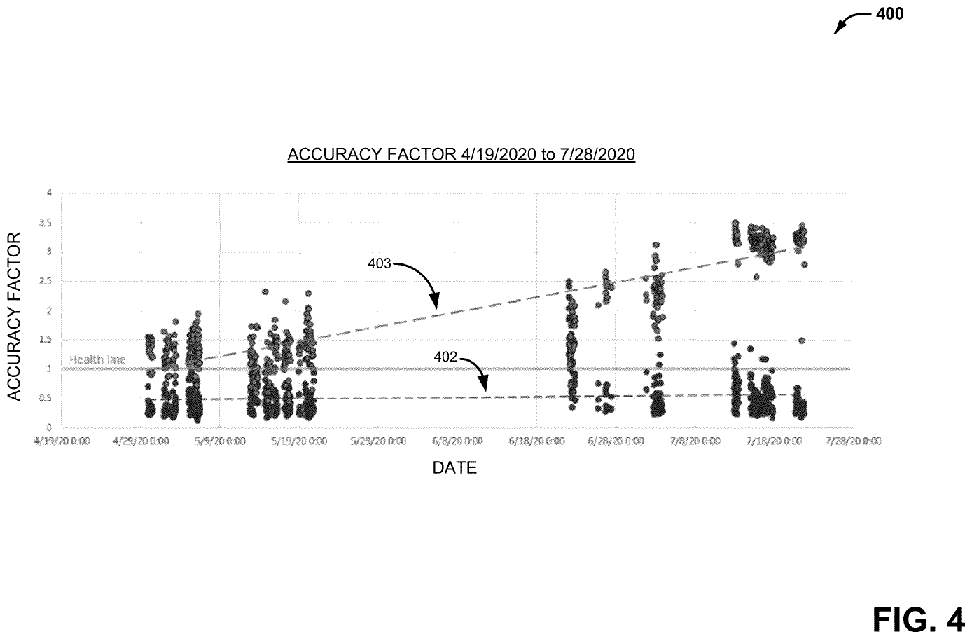

Next, turning briefly to FIG. 4, illustrated is an example accuracy factor graph 400 for a measurement device 250 based on accuracy factors 230 acquired over a period of 3 months. The acquisition was obtained two-fold, based separately on positive polarity and negative polarity spectral data 247 from the measurement device 250. The x-axis provides the date and time of acquisition. The y-axis provides the output accuracy factor 230 (e.g., output by the outputting component 214). As illustrated, for a selected fragment ion 248, the accuracy factors 230 for the measurement device 250, and thus the accuracy for the measurement device 250 more generally, degrades over the 3 month period. Lesser degradation is illustrated for the positive polarity data 402 than for the negative polarity data 403. This can indicate an issue with calibration in a corresponding negative polarity mode, such as due to a calibration standard, software error, and/or instrument error and/or failure, without being limited thereto. As shown, an average health threshold of 1 is satisfied for the negative polarity data 403 at about the 10 day mark of the 3 month period, at which time the notifying component 218 can output an indication of an acquisition issue for the measurement device 250 based on output from the interpreting component 216 (e.g., using the health threshold).

For another example, separately from the FIGS. 3 and 4, two first accuracy factors obtained within a first given time range can be similar, indicating an out-of-calibration state. Differently, two additional accuracy factors obtained over a second time range after the first time range can indicate reduction in measurement device health over time (e.g., the two additional accuracy factors do not merely have values similar to one or both of the two first accuracy factors).

For another example, accuracy factors taken during a same given time period for different measurement devices can be compared to one another. Here, comparison can indicate higher accuracy of one measurement device as compared to another measurement device, for example.

For another example, accuracy factors taken during a same given time period and corresponding to different fragment ions detected at a same measurement device can be compared to one another. Here, comparison can indicate higher accuracy of the measurement device relative to one fragment ion as compared to accuracy of the measurement device relative to another, and different, fragment ion.

In summary, the one or more example embodiments described herein can aid in monitoring spectrometry device health degradation based on determined accuracy as related to specified fragment ions measured by the spectrometry device. For example, the one or more embodiments described herein can facilitate a process to determine and employ expected, acquired and estimated measurement values in an aggregated format to classify a degradation of health of the spectrometry device. This can comprise generating an accuracy factor (e.g., normalized accuracy factor 230) being (e.g., comprise and/or is) a criterion for the accuracy of the spectrometry device 250 that is normalized to an expected m/z 244 of a specified fragment ion 242 and expressed as a multiplier of an estimated accuracy 240 corresponding to the specified fragment ion 242. As a result, a spectral peak corresponding to the specified fragment ion 242, as output by the measurement device 250, can be fit to the expected m/z 244.

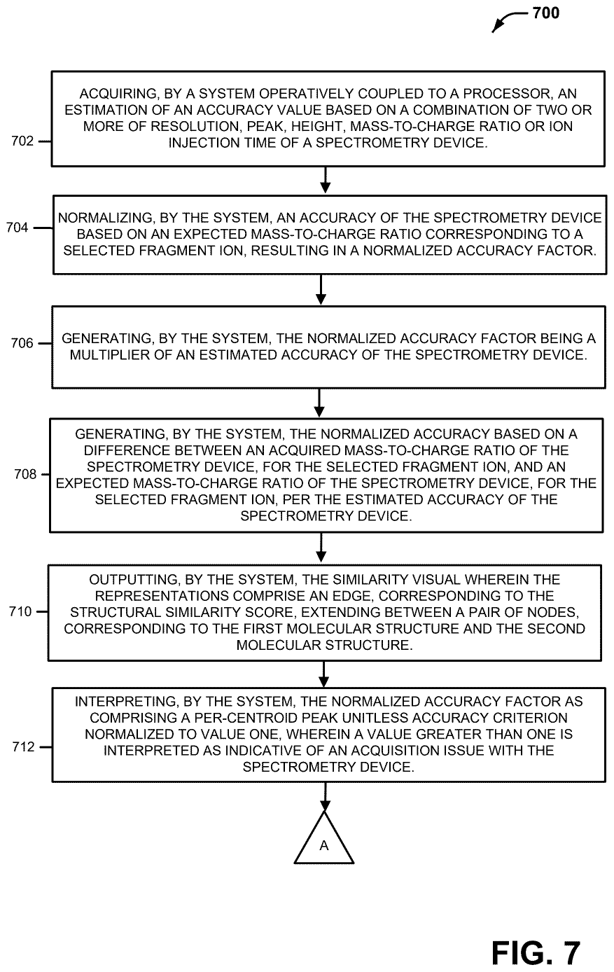

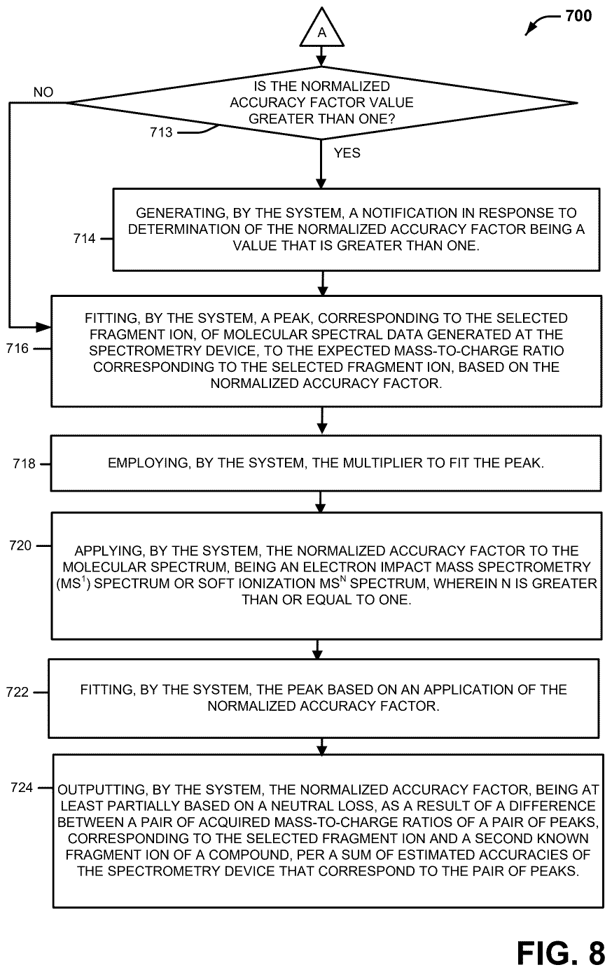

As another summary of the above-described components and/or functions thereof, referring next to FIGS. 7 and 8, illustrated is a flow diagram of an example, non-limiting method 700 that can facilitate a process for measurement device health monitoring, in accordance with one or more example embodiments described herein, such as the non-limiting system 200 of FIG. 2. While the non-limiting method 700 is described relative to the non-limiting system 200 of FIG. 2, the non-limiting method 700 can be applicable also to other systems described herein, such as the non-limiting system 100 of FIG. 1. Repetitive description of like elements and/or processes employed in respective embodiments is omitted for sake of brevity.

At 702, the non-limiting method 700 can comprise acquiring, by a system (e.g., identifying component 210) coupled to a processor (e.g., processor 206), an estimation of an accuracy value (e.g., estimated m/z 240) based on a combination of two or more of resolution, peak, height, mass-to-charge ratio or ion injection time of a spectrometry device (e.g., spectrometry device 250).

At 704, the non-limiting method 700 can comprise normalizing, by the system (e.g., normalizing component 212), an accuracy of the spectrometry device based on an expected mass-to-charge ratio (e.g., expected m/z 244) corresponding to a selected fragment ion (e.g., selected fragment ion 248), resulting in a normalized accuracy factor (e.g., normalized accuracy factor 230).

At 706, the non-limiting method 700 can comprise generating, by the system (e.g., normalizing component 212), the normalized accuracy factor being a multiplier of an estimated accuracy of the spectrometry device.

At 708, the non-limiting method 700 can comprise generating, by the system (e.g., normalizing component 212), the normalized accuracy based on a difference between an acquired mass-to-charge ratio (e.g., acquired m/z 246) of the spectrometry device, for the selected fragment ion, and an expected mass-to-charge ratio (e.g., expected m/z 244) of the spectrometry device, for the selected fragment ion, per the estimated accuracy of the spectrometry device.

At 710, outputting, by the system (e.g., outputting component 214), the normalized accuracy factor as a unitless value.

At 712, the non-limiting method 700 can comprise interpreting, by the system (e.g., interpreting component 216), the normalized accuracy factor as comprising a per-centroid peak unitless accuracy criterion normalized to value one, wherein a value greater than one is interpreted as indicative of an acquisition issue with the spectrometry device.

At 713, the non-limiting method 700 can comprise determining, by the system, (e.g., interpreting component 216) whether the normalized accuracy factor has a value greater than one. If yes, the non-limiting method 700 can proceed to step 714. If not, the non-limiting method 700 can proceed to step 716, bypassing step 714.

At 714, the non-limiting method 700 can comprise generating, by the system (e.g., notifying component 218), a notification (e.g., notification 280) in response to determination of the normalized accuracy factor being a value that is greater than one.

At 716, the non-limiting method 700 can comprise fitting, by the system (e.g., determining component 222), a peak, corresponding to the selected fragment ion, of molecular spectral data generated at the spectrometry device, to the expected mass-to-charge ratio corresponding to the selected fragment ion, based on the normalized accuracy factor.

As described above relative to the determining component 222, fitting can comprise changing, calibrating, determining a delta accuracy 260, etc. for one or more fragment ions including the selected fragment ion 248.

At 718, the non-limiting method 700 can comprise employing, by a system (e.g., determining component 222), the multiplier to fit the peak.

At 720, the non-limiting method 700 can comprise applying, by the system (e.g., determining component 222), the normalized accuracy factor to the molecular spectrum, being an electron impact mass spectrometry (MS¹) spectrum or soft ionization MSⁿ spectrum, wherein n is greater than or equal to one.

At 722, the non-limiting method 700 can comprise fitting, by the system (e.g., determining component 222), the peak based on an application of the normalized accuracy factor.

At 724, the non-limiting method 700 can comprise outputting, by the system (e.g., outputting component 214), the normalized accuracy factor, being at least partially based on a neutral loss, as a result of a difference between a pair of acquired mass-to-charge ratios of a pair of peaks, corresponding to the selected fragment ion and a second selected fragment ion of a compound, per a sum of estimated accuracies of the spectrometry device that correspond to the pair of peaks.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, computer program products and/or computer-implemented methods provided herein described herein relate to a process for monitoring measurement device health degradation. A system can comprise a memory (e.g., memory 104, 204) that stores, and a processor (e.g., processor 106, 206) that executes computer executable components. The computer executable components can comprise a normalizing component 112, 212 that normalizes an accuracy of a spectrometry device 150, 250 based on an expected mass-to-charge ratio 144, 244 corresponding to a selected fragment ion 148, 248, resulting in a normalized accuracy factor 130, 230, and a determining component 122, 222 based on the normalized accuracy factor 130, 230, fits a peak 149, 249, corresponding to the selected fragment ion 148, 248, of molecular spectral data 147, 247 generated at the spectrometry device 150, 250 to the expected mass-to-charge ratio 144, 244 corresponding to the selected fragment ion 148, 248.

That is, the one or more example embodiments described herein can be employed to monitor spectrometry device health degradation based on determined accuracy as related to specified fragment ions measured by the spectrometry device. For example, the one or more embodiments described herein can facilitate a process to determine and employ expected, acquired and estimated measurement values in an aggregated format to classify a degradation of health of the spectrometry device.

This monitoring can comprise normalizing an accuracy of a spectrometry device based on a specified fragment ion, can fit a peak of spectral data based on the normalized accuracy factor, and/or can optionally determine a delta accuracy of the spectrometry device employing data corresponding to the same specified fragment ion. Put another way, the accuracy factor provides a criterion for the accuracy of the spectrometry device that is normalized to an expected m/z of a specified fragment ion and expressed as a multiplier of an estimated accuracy corresponding to the specified fragment ion. As a result, a spectral peak corresponding to the specified fragment ion, as output by the measurement device, can be fit to the expected m/z.

As a result of an output of one or more accuracy factors and/or fittings, one or more resulting delta accuracies can be determined for the spectrometry device. A dataset comprising the one or more accuracy factors and/or delta accuracies can be employed to calibrate, understand accuracy of, and/or compare accuracy of a measurement device, in a time efficient manner. Accordingly, the inventors have discovered that using a known baseline of a selected fragment ion, and its associated mass-to-charge ratio, output of a spectrometry device can be normalized, resulting in a unitless accuracy factor, where the normalized accuracy factor can be employed to determine a delta accuracy of the spectrometry device (e.g., as compared to expected, as compared to historical accuracy for the spectrometry device, etc.).

The one or more example embodiments described herein can be implemented within, in connection with and/or coupled to a scientific measurement device.

The one or more example embodiments disclosed herein can be applied on a plug-and-play basis to various architectures of existing scientific measurement devices. That is, the one or more example embodiments described herein can automatically obtain data corresponding to and output from a measurement device to aid in determining a health of the measurement device absent access to particular hardware and/or software of such measurement device (e.g., being software and/or hardware agnostic).

Indeed, in view of the one or more example embodiments described herein, a practical application of the one or more systems, computer-implemented methods and/or computer program products described herein can be ability to provide the aforementioned accuracy factor and/or delta accuracy, based on a specified/selected fragment ion. As compared to existing frameworks that cannot provide this ability, the one or more example embodiments described herein can provide a new result that was previously unavailable.

These are useful and practical applications of computers, thus providing enhanced (e.g., improved and/or optimized) measurement device health monitoring. Overall, such computerized tools can constitute a concrete and tangible technical improvement in the fields of material analysis, and more particularly in measurement device health monitoring, which measurement device is employed for material analysis.

Furthermore, one or more example embodiments described herein can be employed in a real-world system based on the disclosed teachings. For example, an accuracy factor and/or delta accuracy can be determined, corresponding to a selected fragment ion, for a specified measurement device, for plural different ions corresponding to a single measurement device to allow for comparison therebetween, from a same fragment ion for plural measurement devices to allow for comparison therebetween, and/or for a same measurement device and fragment ion combination over different time periods allowing for an extended health monitoring, without being limited thereto. molecular structural library datastore of molecular structural content can be identified and the content evaluated. Based on at least an accuracy factor, being a unitless and normalized value, a determination can be made of present accuracy of a measurement device. Based on a delta accuracy, a determination can be made as to an extend of accuracy deviation relative to a selected fragment ion analysis. Using plural accuracy factors from different devices, time periods and/or fragment ions, an expanded understanding of measurement device health can be obtained based on one or more comparisons of accuracy factors and/or delta accuracies. These can be useful processes for varying industries employing material analysis, product manufacturing, quality control and/or the like. The embodiments disclosed herein thus can provide improvements to scientific instrument technology (e.g., improvements in the computer technology supporting such scientific instruments, among other improvements).

Moreover, the one or more example embodiments described herein can achieve a level of scale of operation. For example, two or more accuracy factors can be determined at least partially in parallel with one another relative to different devices, time periods and/or fragment ions.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more example embodiments described herein can be, in one or more example embodiments, inherently and/or inextricably tied to computer technology and cannot be implemented outside of a computing environment. For example, one or more processes performed by one or more example embodiments described herein can more efficiently, and even more feasibly, provide program and/or program instruction execution, such as relative to measurement device health monitoring (e.g., measurement device use for material analysis), as compared to existing systems and/or techniques using molecular network generation and/or visualization. Systems, computer-implemented methods and/or computer program products providing performance of these processes are of great utility in the fields of material analysis and cannot be equally practicably implemented in a sensible way outside of a computing environment.

One or more example embodiments described herein can employ hardware and/or software to solve problems that are highly technical, that are not abstract, and that cannot be performed as a set of mental acts by a human. For example, a human, or even thousands of humans, cannot efficiently, accurately and/or effectively analyze computer data/metadata (e.g., spectral data and/or m/z data) defining acquired, estimated and/or expected accuracy corresponding to one or more fragment ions and one or more measurement devices, and/or generate a digital display visual of a delta accuracy, as the one or more example embodiments described herein can provide this process. Moreover, neither can the human mind nor a human with pen and paper conduct one or more of these processes, as conducted by one or more example embodiments described herein.

In one or more example embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more example embodiments described herein and/or components thereof can be employed to solve new problems that arise through advancements in technologies mentioned above, employment of quantum computing systems, cloud computing systems, computer architecture and/or another technology.

One or more example embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: a normalizing component that normalizes an accuracy of a spectrometry device based on an expected mass-to-charge ratio corresponding to a selected fragment ion, resulting in a normalized accuracy factor; and a determining component that, based on the normalized accuracy factor, fits a peak, corresponding to the selected fragment ion, of molecular spectral data generated at the spectrometry device to the expected mass-to-charge ratio corresponding to the selected fragment ion.

The system of the preceding paragraph, wherein the computer executable components further comprise: an outputting component that outputs the normalized accuracy factor as a unitless value.

The system of any preceding paragraph, wherein the normalizing component generates the normalized accuracy factor being a multiplier of an estimated accuracy of the spectrometry device, and wherein the determining component employs the multiplier to fit the peak.

The system of any preceding paragraph, wherein the normalized accuracy factor is based on a difference between an acquired mass-to-charge ratio of the spectrometry device, for the selected fragment ion, and an expected mass-to-charge ratio of the spectrometry device, for the selected fragment ion, per the estimated accuracy of the spectrometry device.

The system of any preceding paragraph, wherein the estimated accuracy comprises an estimation of an accuracy value based on a combination of two or more of resolution, peak, height, mass-to-charge ratio or ion injection time of the spectrometry device.

The system of any preceding paragraph, wherein the computer executable components further comprise: an interpreting component that interprets the normalized accuracy factor as comprising a per-centroid peak unitless accuracy criterion normalized to value one, wherein a value greater than one is interpreted as indicative of an acquisition issue with the spectrometry device; and a notifying component that generates a notification in response to determination of the normalized accuracy factor being a value that is greater than one.

The system of any preceding paragraph, wherein the determining component that applies the normalized accuracy factor to the molecular spectrum, being an electron impact mass spectrometry (MS¹) spectrum or soft ionization MSⁿ spectrum, wherein n is greater than or equal to one, and wherein the determining component fits the peak based on an application of the normalized accuracy factor by the determining component.

The system of any preceding paragraph, wherein the normalized accuracy factor is at least partially based on a neutral loss, and further comprising: an outputting component that outputs the normalized accuracy factor as a result of a difference between a pair of acquired mass-to-charge ratios of a pair of peaks, corresponding to the selected fragment ion and a second selected fragment ion of a compound, per a sum of estimated accuracies of the spectrometry device that correspond to the pair of peaks.

A computer-implemented method, comprising: normalizing, by a system operatively coupled to a processor, an accuracy of a spectrometry device based on an expected mass-to-charge ratio corresponding to a selected fragment ion, resulting in a normalized accuracy factor; and fitting, by the system, based on the normalized accuracy factor, a peak, corresponding to the selected fragment ion, of molecular spectral data generated at the spectrometry device to the expected mass-to-charge ratio corresponding to the selected fragment ion.

The computer-implemented method of the preceding paragraph, further comprising: outputting, by the system, the normalized accuracy factor as a unitless value.

The computer-implemented method of any preceding paragraph, further comprising: generating, by the system, the normalized accuracy factor being a multiplier of an estimated accuracy of the spectrometry device; and employing, by the system, the multiplier to fit the peak.

The computer-implemented method of any preceding paragraph, wherein the normalized accuracy factor is based on a difference between an acquired mass-to-charge ratio of the spectrometry device, for the selected fragment ion, and an expected mass-to-charge ratio of the spectrometry device, for the selected fragment ion, per the estimated accuracy of the spectrometry device.

The computer-implemented method of any preceding paragraph, further comprising: interpreting, by the system, the normalized accuracy factor as comprising a per-centroid peak unitless accuracy criterion normalized to value one, wherein a value greater than one is interpreted as indicative of an acquisition issue with the spectrometry device; and generating, by the system, a notification in response to determination of the normalized accuracy factor being a value that is greater than one.

The computer-implemented method of any preceding paragraph, further comprising: applying, by the system, the normalized accuracy factor to the molecular spectrum, being an electron impact mass spectrometry (MS¹) spectrum or soft ionization MSⁿ spectrum, wherein n is greater than or equal to one, and fitting, by the system, the peak based on the applying of the normalized accuracy factor.

A computer program product facilitating a process for monitoring health of a spectrometry device, the computer program product comprising a computer readable storage medium having program instructions embodied therewith, and the program instructions executable by a processor to cause the processor to: normalize, by the processor, an accuracy of a spectrometry device based on an expected mass-to-charge ratio corresponding to a selected fragment ion, resulting in a normalized accuracy factor; and fit, by the processor, based on the normalized accuracy factor, a peak, corresponding to the selected fragment ion, of molecular spectral data generated at the spectrometry device to the expected mass-to-charge ratio corresponding to the selected fragment ion.

The computer program product of the preceding paragraph, wherein the program instructions are further executable by the processor to cause the processor to: output, by the processor, the normalized accuracy factor as a unitless value.

The computer program product of any preceding paragraph, wherein the program instructions are further executable by the processor to cause the processor to: generate, by the processor, the normalized accuracy factor being a multiplier of an estimated accuracy of the spectrometry device; and employ, by the processor, the multiplier to fit the peak.

The computer program product of any preceding paragraph, wherein the normalized accuracy factor is based on a difference between an acquired mass-to-charge ratio of the spectrometry device, for the selected fragment ion, and an expected mass-to-charge ratio of the spectrometry device, for the selected fragment ion, per the estimated accuracy of the spectrometry device.

The computer program product of any preceding paragraph, wherein the program instructions are further executable by the processor to cause the processor to: interpret, by the processor, the normalized accuracy factor as comprising a per-centroid peak unitless accuracy criterion normalized to value one, wherein a value greater than one is interpreted as indicative of an acquisition issue with the spectrometry device; and generate, by the processor, a notification in response to determination of the normalized accuracy factor being a value that is greater than one.

The computer program product of any preceding paragraph, wherein the program instructions are further executable by the processor to cause the processor to: apply, by the processor, the normalized accuracy factor to the molecular spectrum, being an electron impact mass spectrometry (MS¹) spectrum or soft ionization MSⁿ spectrum, wherein n is greater than or equal to one, and fit, by the processor, the peak based on the applying of the normalized accuracy factor.

### Example Operating Environment

FIG. 9 is a schematic block diagram of an operating environment 900 with which the described subject matter can interact. The operating environment 900 comprises one or more remote component(s) 910. The remote component(s) 910 can be hardware and/or software (e.g., threads, processes, computing devices). In one or more example embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The operating environment 900 also comprises one or more local component(s) 920. The local component(s) 920 can be hardware and/or software (e.g., threads, processes, computing devices). In one or more example embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The operating environment 900 comprises a communication framework 940 that can be employed to facilitate communications between the remote component(s) 910 and the local component(s) 920, and can comprise an air interface, e.g., interface of a UMTS network, via an LTE network, etc. Remote component(s) 910 can be operably connected to one or more remote data store(s) 950, such as a hard drive, solid state drive, subscriber identity module (SIM) card, electronic SIM (eSIM), device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

### Example Computing Environment

In order to provide additional context for various embodiments described herein, FIG. 10 and the following discussion are intended to provide a brief, general description of a suitable computing environment 1900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 10, the example computing environment 1000 which can implement one or more example embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), and can include one or more external storage devices 1016 (e.g., a magnetic floppy disk drive (FDD) 1016, a memory stick or flash drive reader, a memory card reader, etc.). While the internal HDD 1014 is illustrated as located within the computer 1002, the internal HDD 1014 can also be configured for external use in a suitable chassis (not shown). Additionally, while not shown in computing environment 1000, a solid-state drive (SSD) could be used in addition to, or in place of, an HDD 1014.

Other internal or external storage can include at least one other storage device 1020 with storage media 1022 (e.g., a solid-state storage device, a nonvolatile memory device, and/or an optical disk drive that can read or write from removable media such as a CD-ROM disc, a DVD, a BD, etc.). The external storage 1016 can be facilitated by a network virtual machine. The HDD 1014, external storage device 1016 and storage device (e.g., drive) 1020 can be connected to the system bus 1008 by an HDD interface 1024, an external storage interface 1026 and a drive interface 1028, respectively.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user entity can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer 1050. The remote computer 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. The network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with an existing network or simply an ad hoc communication between at least two devices.

### Additional Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more example embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more example embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more example embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more example embodiments described herein.

Aspects of the one or more example embodiments described herein are described with reference to flowchart illustrations and/or block diagrams of methods, apparatus (systems), and computer program products according to one or more example embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more example embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more example embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more example embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more example embodiments, but one of ordinary skill in the art can recognize that many further combinations and/or permutations of the one or more example embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments can use the phrases “an embodiment,” “various embodiments,” “one or more example embodiments” and/or “some embodiments,” each of which can refer to one or more of the same or different embodiments.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a normalizing component that normalizes an accuracy of a spectrometry device based on an expected mass-to-charge ratio corresponding to a selected fragment ion, resulting in a normalized accuracy factor; and
a determining component that, based on the normalized accuracy factor, fits a peak, corresponding to the selected fragment ion, of molecular spectral data generated at the spectrometry device to the expected mass-to-charge ratio corresponding to the selected fragment ion.

2. The system of claim 1, wherein the computer executable components further comprise:
an outputting component that outputs the normalized accuracy factor as a unitless value.

3. The system of claim 1,
wherein the normalizing component generates the normalized accuracy factor being a multiplier of an estimated accuracy of the spectrometry device, and
wherein the determining component employs the multiplier to fit the peak.

4. The system of claim 3, wherein the normalized accuracy factor is based on a difference between an acquired mass-to-charge ratio of the spectrometry device, for the selected fragment ion, and an expected mass-to-charge ratio of the spectrometry device, for the selected fragment ion, per the estimated accuracy of the spectrometry device.

5. The system of claim 3, wherein the estimated accuracy comprises an estimation of an accuracy value based on a combination of two or more of resolution, peak, height, mass-to-charge ratio or ion injection time of the spectrometry device.

6. The system of claim 1, wherein the computer executable components further comprise:
an interpreting component that interprets the normalized accuracy factor as comprising a per-centroid peak unitless accuracy criterion normalized to value one, wherein a value greater than one is interpreted as indicative of an acquisition issue with the spectrometry device; and
a notifying component that generates a notification in response to determination of the normalized accuracy factor being a value that is greater than one.

7. The system of claim 1, wherein the determining component that applies the normalized accuracy factor to the molecular spectrum, being an electron impact mass spectrometry (MS¹) spectrum or soft ionization MSⁿ spectrum,
wherein n is greater than or equal to one, and
wherein the determining component fits the peak based on an application of the normalized accuracy factor by the determining component.

8. The system of claim 1,
wherein the normalized accuracy factor is at least partially based on a neutral loss, and further comprising:
an outputting component that outputs the normalized accuracy factor as a result of a difference between a pair of acquired mass-to-charge ratios of a pair of peaks, corresponding to the selected fragment ion and a second selected fragment ion of a compound, per a sum of estimated accuracies of the spectrometry device that correspond to the pair of peaks.

9. A computer-implemented method, comprising:
normalizing, by a system operatively coupled to a processor, an accuracy of a spectrometry device based on an expected mass-to-charge ratio corresponding to a selected fragment ion, resulting in a normalized accuracy factor; and
fitting, by the system, based on the normalized accuracy factor, a peak, corresponding to the selected fragment ion, of molecular spectral data generated at the spectrometry device to the expected mass-to-charge ratio corresponding to the selected fragment ion.

10. The computer-implemented method of claim 9, further comprising:
outputting, by the system, the normalized accuracy factor as a unitless value.

11. The computer-implemented method of claim 9, further comprising:
generating, by the system, the normalized accuracy factor being a multiplier of an estimated accuracy of the spectrometry device; and
employing, by the system, the multiplier to fit the peak.

12. The computer-implemented method of claim 11, wherein the normalized accuracy factor is based on a difference between an acquired mass-to-charge ratio of the spectrometry device, for the selected fragment ion, and an expected mass-to-charge ratio of the spectrometry device, for the selected fragment ion, per the estimated accuracy of the spectrometry device.

13. The computer-implemented method of claim 9, further comprising:
interpreting, by the system, the normalized accuracy factor as comprising a per-centroid peak unitless accuracy criterion normalized to value one, wherein a value greater than one is interpreted as indicative of an acquisition issue with the spectrometry device; and
generating, by the system, a notification in response to determination of the normalized accuracy factor being a value that is greater than one.

14. The computer-implemented method of claim 9, further comprising:
applying, by the system, the normalized accuracy factor to the molecular spectrum, being an electron impact mass spectrometry (MS¹) spectrum or soft ionization MSⁿ spectrum,
wherein n is greater than or equal to one, and
fitting, by the system, the peak based on the applying of the normalized accuracy factor.

15. A computer program product facilitating a process for monitoring health of a spectrometry device, the computer program product comprising a computer readable storage medium having program instructions embodied therewith, and the program instructions executable by a processor to cause the processor to:
normalize, by the processor, an accuracy of a spectrometry device based on an expected mass-to-charge ratio corresponding to a selected fragment ion, resulting in a normalized accuracy factor; and
fit, by the processor, based on the normalized accuracy factor, a peak, corresponding to the selected fragment ion, of molecular spectral data generated at the spectrometry device to the expected mass-to-charge ratio corresponding to the selected fragment ion.

16. The computer program product of claim 15, wherein the program instructions are further executable by the processor to cause the processor to:
output, by the processor, the normalized accuracy factor as a unitless value.

17. The computer program product of claim 15, wherein the program instructions are further executable by the processor to cause the processor to:
generate, by the processor, the normalized accuracy factor being a multiplier of an estimated accuracy of the spectrometry device; and
employ, by the processor, the multiplier to fit the peak.

18. The computer program product of claim 16, wherein the normalized accuracy factor is based on a difference between an acquired mass-to-charge ratio of the spectrometry device, for the selected fragment ion, and an expected mass-to-charge ratio of the spectrometry device, for the selected fragment ion, per the estimated accuracy of the spectrometry device.

19. The computer program product of claim 15, wherein the program instructions are further executable by the processor to cause the processor to:
interpret, by the processor, the normalized accuracy factor as comprising a per-centroid peak unitless accuracy criterion normalized to value one, wherein a value greater than one is interpreted as indicative of an acquisition issue with the spectrometry device; and
generate, by the processor, a notification in response to determination of the normalized accuracy factor being a value that is greater than one.

20. The computer program product of claim 15, wherein the program instructions are further executable by the processor to cause the processor to:
apply, by the processor, the normalized accuracy factor to the molecular spectrum, being an electron impact mass spectrometry (MS¹) spectrum or soft ionization MSⁿ spectrum,
wherein n is greater than or equal to one, and
fit, by the processor, the peak based on the applying of the normalized accuracy factor.
